(19) United States
(12) Patent Application Publication
(10) Pub. No.: US 2013/0329435 A1
(43) Pub. Date: Dec. 12, 2013

(54) LED LIGHTING UNIT

(71) Applicant: Yazaki Corporation, Tokyo (JP)

(72) Inventor: Harumi KAWASE, Makinohara-shi (JP)

(73) Assignee: Yazaki Corporation, Tokyo (JP)

(21) Appl. No.: 13/968,624

(22) Filed: Aug. 16, 2013

Related U.S. Application Data
(63) Continuation of application No. PCT/JP2012/062733, filed on May 11, 2012.

(30) Foreign Application Priority Data
May 11, 2011 (JP) 2011-105828

(51) Int. Cl. F21V 19/00; F21V 11/00

(52) U.S. Cl. CPC F21V 19/002; F21V 11/00
USPC 362/311.02

(57) ABSTRACT

When the edge surfaces of the circuit board side cut-out part and the light screen member side cut-out part which are respectively orthogonal to the cutting directions are allowed to abut on each other so as to attach the light screen member to the circuit board, the light screen member is attached to the circuit board so that both the end surfaces of the light screen member opposed to each other in the cutting direction of the light screen member side cut-out part are arranged more inside than both the end faces of the circuit board opposed to each other in the cutting direction of the circuit board side cut-out part.

### CROSS REFERENCE TO RELATED APPLICATION

This application is a continuation of PCT application No. PCT/JP2012/062733, which was filed on May 11, 2012 based on Japanese Patent Application No. 2011-105828 filed on May 11, 2011, the contents of which are incorporated herein by reference. Also, all the references cited herein are incorporated as a whole.

### BACKGROUND OF THE INVENTION

1. Field of the Invention

The present invention relates to an LED lighting unit having a circuit board on which a plurality of LED elements are mounted, and a light transmitting housing in which the circuit board is accommodated.

2. Description of the Relate Art

Usually, a device is known that a plurality of LED elements are provided on a circuit board and lights emitted respectively from the LED elements are used as illuminating lights or colored lights such as orange lights are emitted from the LED elements to show an operating state of the device. For instance, JP-A-11-101664 proposes a display device for a vehicle which functions as what is called an indicator by lights emitted from a plurality of LED elements.

The display device for the vehicle disclosed in the JP-A-11-101664 includes scales arranged in the forms of circles or circular arcs in a dial, indexes such as figures, characters or symbols attached to the scales, one or a plurality of light sources arranged so as to individually correspond to the scales of the dial respectively and a display control unit which sets a measured value as a reference value to turn on the light sources within a prescribed range of the reference value or lower and brighten the scales within the prescribed range corresponding to a measured amount so that the prescribed range is displayed on the dial. Thus, the measured amount is displayed in cooperation of the display of the prescribed range with the indexes such as the figures, the characters or the symbols attached to the scales of the dial.

However, in the display device for the vehicle disclosed in the JP-A-11-101664, since a circuit board, a light screen plate and the dial need to be respectively positioned and attached to a case, there is possibility in that an attaching operation is complicated.

### SUMMARY OF THE INVENTION

The present invention has been made in view of the situations that are described above, and it is an object of this invention to provide with an LED lighting unit which can make an attaching operation easy.

In order to achieve the object, according to the first aspect of the present invention, a LED lighting unit has a circuit board on which a plurality of LED elements are mounted and a light transmitting housing in which the circuit board is accommodated. The LED lighting unit includes a light screen cover formed so as to cover an outer surface of the light transmitting housing and having light output opening parts formed on walls respectively opposed to the plurality of LED elements and a light screen member formed in a shape of a plate so as to be accommodated in the light transmitting housing with an outer peripheral edge surface allowed to come into sliding contact with an inner surface of the light transmitting housing and having a light screen member side cut-out part as a rectangular cut-out part which is cut from the outer peripheral edge surface to an inner part and has a width orthogonal to a cutting direction formed to be substantially equal to the thickness of the circuit board, and is characterized in that the circuit board has a circuit board side cut-out part as a rectangular cut-out part which is cut from one end face of a pair of end faces opposed to each other in a direction orthogonal to an inserting direction to the light transmitting housing to an inner part of the circuit board, has a width orthogonal to a cutting direction formed to be substantially equal to the thickness of the light screen member and is arranged between the plurality of LED elements respectively, and when edge surfaces of the light screen member side cut-out part and the circuit board side cut-out part respectively orthogonal to the cutting directions are allowed to abut on each other to attach the light screen member to the circuit board, both end surfaces of the light screen member opposed to each other in the cutting direction of the light screen member side cut-out part are arranged more inside than both the end faces of the circuit board opposed to each other in the cutting direction of the circuit board side cut-out part.

Further, in an LED lighting unit defined in a second aspect of the present invention in the above-described invention, the light transmitting housing has a pair of guide groove parts formed so as to guide respectively both end parts of the circuit board opposed to each other in the direction orthogonal to the inserting direction of the circuit board to the light transmitting housing and abutting parts which abut on the light screen member inserted into the light transmitting housing, and when the end parts of the circuit board are respectively guided by the pair of guide groove parts to insert the circuit board into the light transmitting housing, the light screen member is allowed to abut on the abutting parts, so that the circuit board is arranged in an attaching position in the light transmitting housing.

Further, in an LED lighting unit defined in a third aspect of the present invention in the above-described invention, the light screen member has a light screen member side engaging part provided on at least one edge surface of a pair of edge surfaces opposed to each other in a direction orthogonal to the cutting direction of the light screen member side cut-out part and the circuit board has a circuit board side engaging part which is arranged on an extending line of the cutting direction of the circuit board side cut-out part and is engaged with the light screen member side engaging part.

According to the first aspect of the present invention, when the edge surfaces of the circuit board side cut-out part and the light screen member side cut-out part which are respectively orthogonal to the cutting directions are allowed to abut on each other so as to attach the light screen member to the circuit board, the light screen member is attached to the circuit board so that both the end surfaces of the light screen member opposed to each other in the cutting direction of the light screen member side cut-out part are arranged more inside than both the end faces of the circuit board opposed to each other in the cutting direction of the circuit board side cut-out part. Accordingly, when the circuit board is arranged in the attaching position in the light transmitting housing, the light screen member is arranged in the attaching position in the light transmitting housing. Therefore, an attaching operation can be made to be easy.

Further, According to the second aspect of the present invention, when the end parts of the circuit board are respectively guided by the one pair of guide groove parts to insert the circuit board into the light transmitting housing, the light screen member is allowed to abut on the abutting parts. Thus, the circuit board is arranged in the attaching position in the light transmitting housing. Accordingly, the circuit board can be easily attached to the attaching position in the light transmitting housing.

Further, according to the third aspect of the present invention, when the light screen member side engaging part is engaged with the circuit board side engaging part, the light screen member is engaged with the circuit board. Thus, the light screen member can be assuredly fixed to the circuit board.

### BRIEF DESCRIPTION OF DRAWINGS

FIG. 1 is an exploded perspective view showing an LED lighting unit according to an embodiment of the present invention.

FIG. 2 is a perspective view showing the LED lighting unit shown in FIG. 1.

FIG. 3 is a sectional view taken along a line A-A of the LED lighting unit shown in FIG. 2.

FIG. 4 is an enlarged perspective view of a light transmitting housing shown in FIG. 1.

FIG. 5 is a sectional view taken along a line C-C of the light transmitting housing shown in FIG. 4.

FIG. 6 is a perspective view of the light transmitting housing shown in FIG. 1 which is seen from a rear side.

FIG. 7 is a perspective view showing a circuit board to which a light screen member shown in FIG. 1 is attached.

FIG. 8 is a sectional view taken along a line B-B of the LED lighting unit shown in FIG. 2.

FIG. 9A is a diagram showing an attaching procedure of the LED lighting unit of the embodiment of the present invention.

FIG. 9B is a diagram showing an attaching procedure of the LED lighting unit of the embodiment of the present invention.

FIG. 10A is a diagram showing an attaching procedure of the LED lighting unit of the embodiment of the present invention.

FIG. 10B is a diagram showing an attaching procedure of the LED lighting unit of the embodiment of the present invention.

FIG. 11 is a sectional view of main parts of an LED lighting unit of a first modified example of the embodiment of the present invention.

FIG. 12 is a perspective view of an LED unit part and a light screen member of an LED lighting unit of a second modified example of the embodiment of the present invention.

FIG. 13 is a perspective view showing an LED lighting unit of a third modified example of the embodiment of the present invention.

### DESCRIPTION OF THE PREFERRED EMBODIMENTS

Now, by referring to the drawings, a preferred embodiment of an LED lighting unit according to the present invention will be described below in detail.

### Embodiment

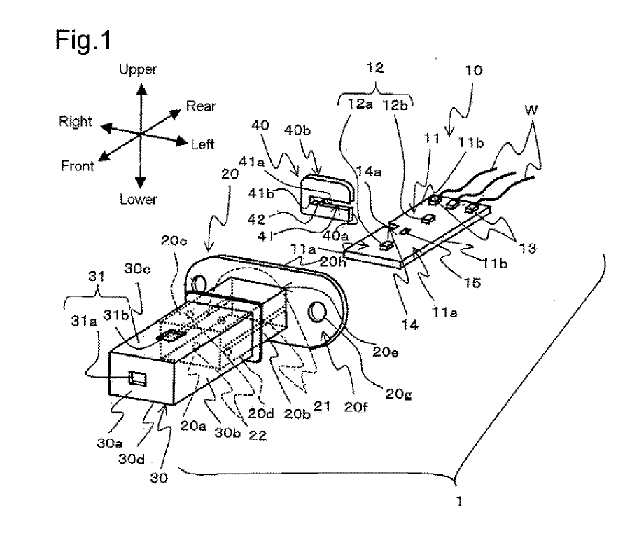

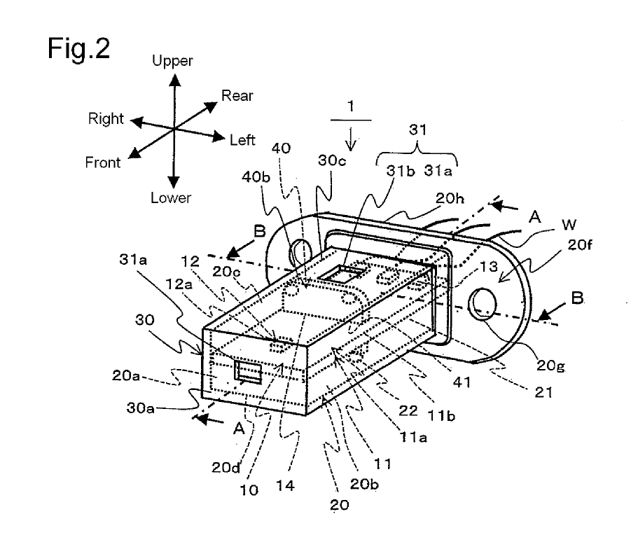

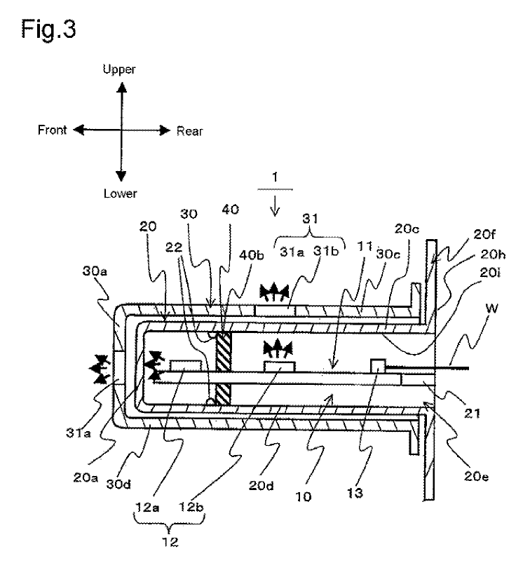

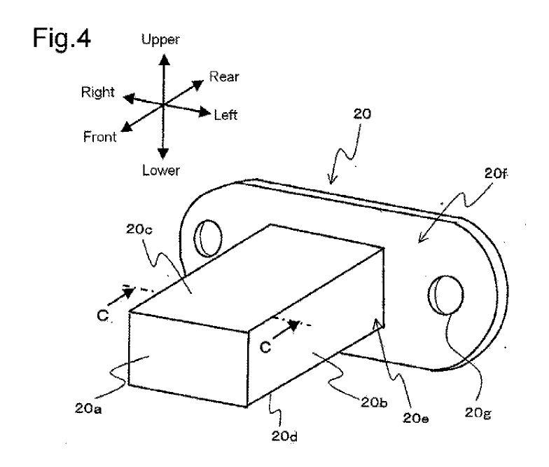

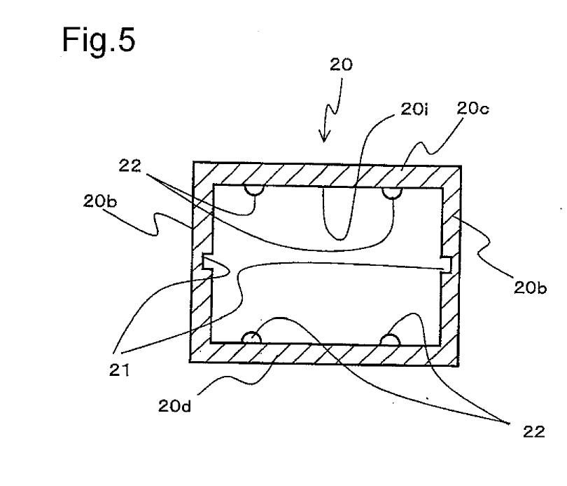

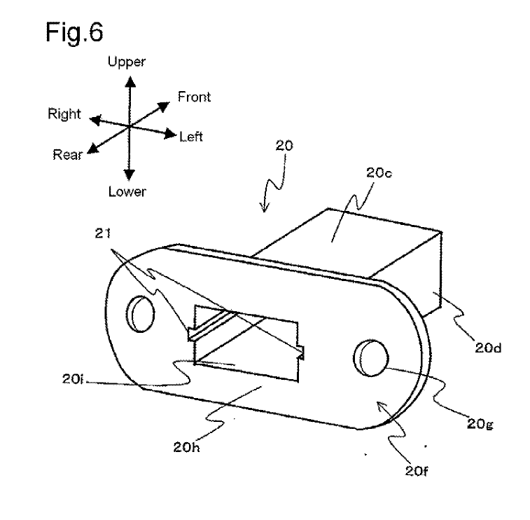

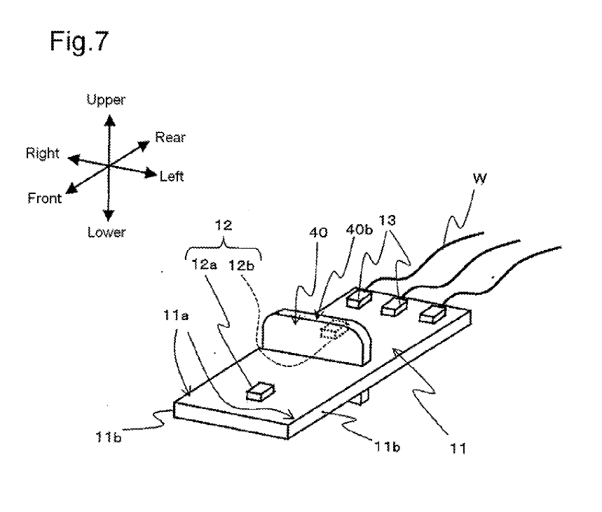

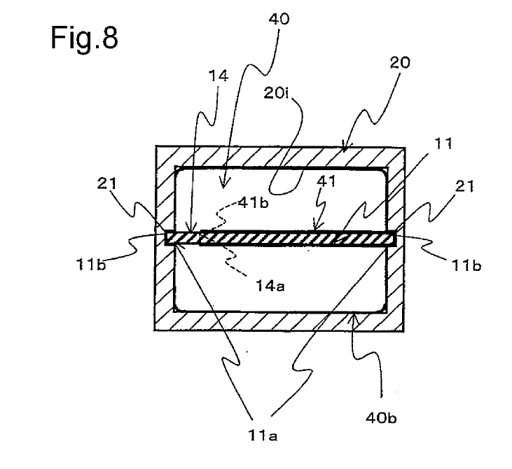

FIG. 1 is an exploded perspective view showing an LED lighting unit 1 according to an embodiment of the present invention. FIG. 2 is a perspective view showing the LED lighting unit shown in FIG. 1. FIG. 3 is a sectional view taken along a line A-A of the LED lighting unit 1 shown in FIG. 2. FIG. 4 is an enlarged perspective view of a light transmitting housing 20 shown in FIG. 1. FIG. 5 is a sectional view taken along a line C-C of the light transmitting housing 20 shown in FIG. 4. FIG. 6 is a perspective view of the light transmitting housing 20 shown in FIG. 1 which is seen from a rear side. FIG. 7 is a perspective view showing a circuit board 11 to which a light screen member 40 shown in FIG. 1 is attached. FIG. 8 is a sectional view taken along a line B-B of the LED lighting unit 1 shown in FIG. 2.

For convenience sake, mutually orthogonal directions shown by arrow marks in the drawing are set to front and rear, right and left and upper and lower directions.

The LED lighting unit 1 according to the embodiment of the present invention includes an LED unit part 10, a light transmitting housing 20, a light screen cover 30 and a light screen member 40.

Initially, the LED unit part 10 is described.

The LED unit part 10 includes a circuit board 11, two LED elements 12 and an electric wire W.

The circuit board 11 is realized by what is called a printed wiring board and a conductor pattern such as a power circuit is formed thereon. The circuit board 11 has a plurality of LED elements 12 mounted on the surface of the board. In the present embodiment, the circuit board 11 is connected to three electric wires W as signal lines or feeder lines through terminals 13 formed on the board. The electric wires W are respectively connected to the terminals 13 by carrying out a soldering process.

The two LED elements 12 respectively have light emitting parts provided on the surfaces of box shaped packages and power supply input terminals not shown in the drawing are connected to the power circuit on the circuit board 11 not shown in the drawing. The power circuit which is not shown in the drawing is connected to the three electric wires W through the terminals 13 provided on the circuit board 11. The LED elements 12 to which an electric power is supplied through the power circuit are respectively turned on.

The LED element 12 of the two LED elements 12 (refer it to as a front side LED element 12a, hereinafter) arranged in a front side position of the circuit board 11 emits, for instance, orange light, and functions as an illumination for showing an operating state of a device depending on the kinds of color. Namely, the LED lighting unit 1 is allowed to function as what is called an indicator.

Further, the LED element 22 (refer it to as a rear side LED element 12b, hereinafter) arranged in a more rearward position on the circuit board 11 than the front side LED element 12a emits white light. Namely, the LED lighting unit 1 is allowed to function as a lighting device.

The circuit board 11 has a circuit board side cut-out part 14 and a circuit board side engaging part 15.

The circuit board side cut-out part 14 is a rectangular cut-out part which is cut to an inner part of the circuit board 11 from one end face 11b of one pair of end faces 11b opposed to each other in a direction orthogonal to an inserting direction to the light transmitting housing 20. The circuit board side cut-out part 14 has a width orthogonal to the cutting direction formed to be substantially equal to the thickness of the light screen member 40. The circuit board side cut-out part 14 is arranged between the two LED elements 12 respectively.

The circuit board side engaging part 15 is arranged on an extending line of the cutting direction of the circuit board side cut-out part 14 and engaged with a below-described light screen member side engaging part 42. More specifically, the circuit board side engaging part 15 is a through hole formed so as to be arranged on the extending line of the cutting direction of the circuit board side cut-out part 14 and pass through the circuit board 11. A protruding part of the below-described screen member side engaging part 42 is engaged with the through hole so that the light screen member 40 is engaged with the circuit board 11.

Now, the light transmitting housing 20 will be described below. The light transmitting housing 20 is made of a light transmitting synthetic resin and has a rectangular tubular form with a bottom including a bottom wall 20a of a rectangular form as an outer form, a pair of side walls 20b standing upright along edges of the bottom wall 20a, an upper wall 20c and a lower wall 20d. The circuit board 11 is accommodated in the light transmitting housing 20. The light transmitting housing 20 has a flange part 20f protruding along an outer periphery of an opening side end part 20e. Bolts not shown in the drawing are inserted into bolt insert holes 20g formed so as to pass through the flange part 20f so that the light transmitting housing 20 is fixed to an installed position.

Further, the light transmitting housing 20 has one pair of guide groove parts 21 and abutting parts 22.

The one pair of guide groove parts 21 are groove parts respectively formed so as to guide both end parts 11a of the circuit board 11 opposed to each other in a direction orthogonal to the inserting direction of the circuit board 11 in the light transmitting housing 20. More specifically, the one pair of guide groove parts 21 are the groove parts respectively linearly formed from an opening side end 20h of the light transmitting housing 20 to an inner part of the light transmitting housing 20 inside the one pair of opposed side walls 20b of the light transmitting housing 20. The one pair of guide groove parts 21 respectively have widths of grooves formed to be substantially equal to the thickness of the circuit board 11.

The abutting parts 22 are parts which abut on the light screen member 40 inserted into the light transmitting housing 20. The abutting parts 22 are protruding parts protruding in hemispherical forms from an inner surface of the upper wall 20c and an inner surface of the lower wall 20d. The abutting parts 22 are provided at two positions of the upper wall 20c and at two positions of the lower wall 20d along the direction orthogonal to the inserting direction of the circuit board 11.

When the end parts 11a of the circuit board 11 are respectively guided by the guide groove parts 21 so that the circuit board 11 is inserted into the light transmitting housing 20, the abutting parts 22 are allowed to abut on the light screen member 40. Thus, the circuit board 11 is positioned to an attaching position in the light transmitting housing 20.

Now, the light screen cover 30 will be described below.

The light screen cover 30 is made of a synthetic resin having a light screen property and has a rectangular tubular form with a bottom including a bottom wall 30a of a rectangular form as an outer form, a pair of side walls 30b standing upright along edges of the bottom wall 30a, an upper wall 30c and a lower wall 30d. The light screen cover 30 is formed so as to cover an outer surface of the light transmitting housing 20.

The light screen cover 30 has two light output opening parts 31 as openings formed so as to output the lights emitted from the two LED elements 12 outside the light screen cover 30.

The two light output opening parts 31 are respectively arranged correspondingly to the arrangement of the LED elements 22 provided on the circuit board 11. More specifically, the light output opening part 31 (refer it to as a front side light output opening part 31a, hereinafter) of the two light output opening parts 31 arranged correspondingly to the arrangement of the front side LED element 12a is arranged at a position of the bottom wall 30a of the light screen cover 30 opposed to the front side LED element 12a.

Further, the light output opening part 31 (refer it to as a rear side light output opening part 31b, hereinafter) arranged correspondingly to the arrangement of the rear side LED element 22b is arranged at a position of the upper wall 30c of the light screen cover 30 opposed to the rear side LED element 12b.

Since the outer surface of the light transmitting housing 20 is covered with such a light screen cover 30, after the lights emitted respectively from the LED elements 12 pass through the light transmitting housing 20, the lights are respectively outputted outside the light screen cover 30 through the light output opening parts 31 arranged correspondingly to the LED elements 12.

Now, the light screen member 40 will be described below.

The light screen member 40 is a plate member having light screen property and including an outer peripheral edge surface 40b which comes into sliding contact with an inner surface 20i of the light transmitting housing 20 so that the light screen member is accommodated in the light transmitting housing 20.

The light screen member 40 has a light screen member side cut-out part 41 and a light screen member side engaging part 42.

The light screen member side cut-out part 41 is a rectangular cut-out part which is cut from the outer peripheral edge surface 40b to an inner part and has a width orthogonal to a cutting direction formed to be substantially equal to the thickness of the circuit board 11.

The light screen member side engaging part 42 is a protruding part protruding from a lower edge surface 41a of a pair of edge surfaces 41a opposed to each other in a direction orthogonal to the cutting direction of the light screen member side cut-out part 41.

When an edge surface 41b of the light screen member side cut-out part 41 orthogonal to the cutting direction is allowed to abut on an edge surface 14a of the circuit board side cut-out part 14 orthogonal to the cutting direction so that the light screen member 40 is attached to the circuit board 11, the light screen member side engaging part 42 is engaged with the circuit board side engaging part 15. Thus, the light screen member 40 is engaged with the circuit board 11.

Further, since the circuit board side cut-out part 14 is arranged between the front side LED element 12a and the rear side LED element 12b, the light screen member 40 is arranged between the front side LED element 12a and the rear side LED element 12b. Thus, the light screen member 40 functions as a partition plate that divides an accommodating space in the light transmitting housing 20 into two parts for the front side LED element 12a and the rear side LED element 12b. Accordingly, the lights respectively emitted from the LED elements 12 are prevented from interfering with each other.

Further, when the edge surface 41b of the light screen member side cut-out part 41 orthogonal to the cutting direction is allowed to abut on the edge surface 14a of the circuit board side cut-out part 14 orthogonal to the cutting direction so that the light screen member 40 is attached to the circuit board 11, both end surfaces 40a of the light screen member 40 opposed to each other in the cutting direction of the light screen member side cut-out part 41 are arranged more inside than both the end faces 11b of the circuit board 11 opposed to each other in the cutting direction of the circuit board side cut-out part 14. Namely, as shown in FIG. 7, the width of the circuit board 11 in the direction orthogonal to the inserting direction is set to be larger than the width of the light screen member 40 attached to the circuit board 11 in the same direction. Amounts of cutting of the light screen member side cut-out part 41 and the circuit board side cut-out part 14 are respectively set so that both the end surfaces 40a of the light screen member 40 opposed to each other in the cutting direction of the light screen member side cut-out part 41 are arranged more inside than both the end faces 11b of the circuit board 11 opposed to each other in the cutting direction of the circuit board side cut-out part 14.

In such a way, when the light screen member 40 is attached to the circuit board 11 so as to attach the circuit board 11 to the light transmitting housing 20, the end parts 11a of the circuit board 11 are respectively guided by the guide groove parts 21 so that the circuit board 11 is inserted into the light transmitting housing 20. Further, when the light screen member 40 is allowed to abut on the abutting parts 22, the circuit board 11 is positioned to an attaching position in the light transmitting housing 20.

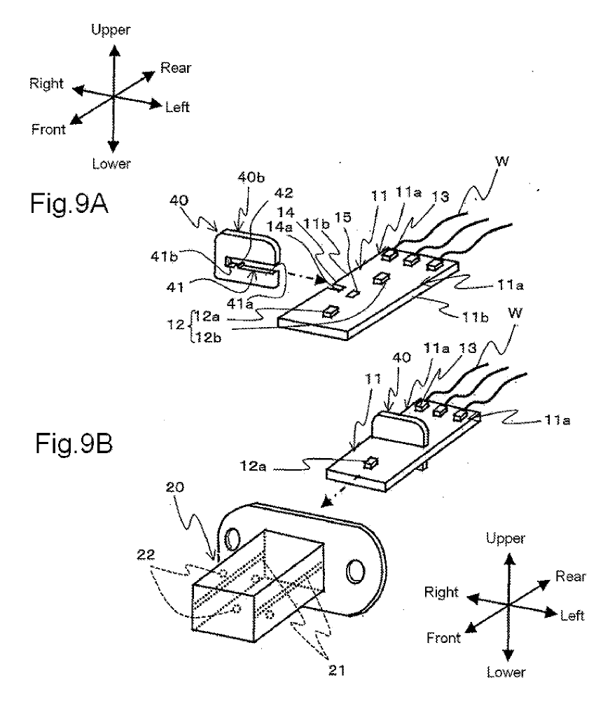

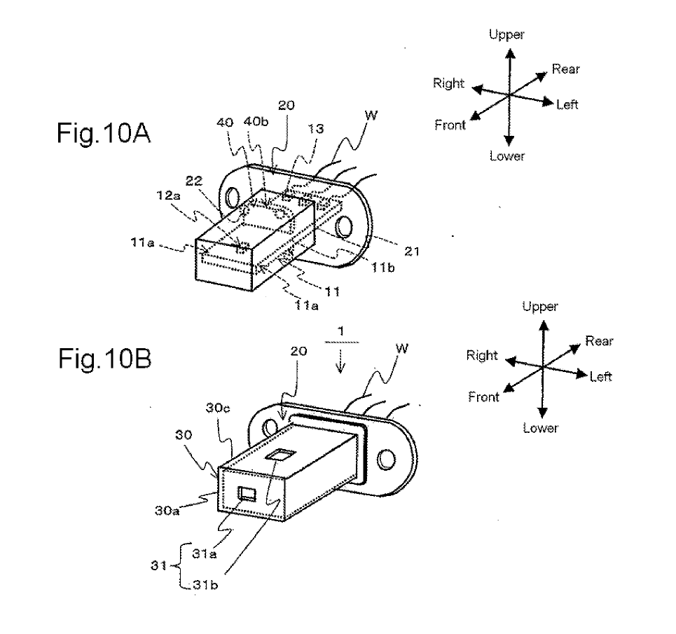

Now, an attaching procedure of the LED lighting unit 1 will be described below by referring to FIGS. 9(a) to 10(b). FIGS. 9(a) to 9(b) and FIGS. 10(a) to 10(b) are diagrams showing the attaching procedure of the LED lighting unit 1 of the embodiment of the present invention.

Initially, an operator attaches the light screen member 40 to the circuit board 11 so that the edge surfaces 14a and 41b of the circuit board side cut-out part 14 and the light screen member side cut-out part 41 which are respectively orthogonal to the cutting directions are allowed to abut on each other (see FIG. 9A). At this time, both the end surfaces 40a of the light screen member 40 opposed to each other in the cutting direction of the light screen member side cut-out part 41 are arranged more inside than both the end faces 11b of the circuit board 11 opposed to each other in the cutting direction of the circuit board side cut-out part 14. Then, the light screen member side engaging part 42 is engaged with the circuit board side engaging part 15, so that the light screen member 40 is engaged with the circuit board 11.

After that, the operator inserts the circuit board 11 into the light transmitting housing 20 (see FIG. 9B). When the circuit board 11 is inserted into the light transmitting housing 20, both the end parts 11a of the circuit board 11 are guided by the one pair of guide groove parts 21 to insert the circuit board 11 into the light transmitting housing 20.

Subsequently, the operator arranges the circuit board 11 in an attaching position in the light transmitting housing 20 (see FIG. 10A). At this time, when the light screen member 40 is allowed to abut on the abutting parts 22, the circuit board 11 is positioned to the attaching position in the light transmitting housing 20.

Then, the operator attaches the light screen cover 30 to the light transmitting housing 20 (see FIG. 10B). Thus, the LED lighting unit 1 is completed.

In the LED lighting unit 1 according to the embodiment of the present invention, when the edge surfaces 14a and 41b of the circuit board side cut-out part 14 and the light screen member side cut-out part 41 which are respectively orthogonal to the cutting directions are allowed to abut on each other so as to attach the light screen member 40 to the circuit board 11, the light screen member 40 is attached to the circuit board 11 so that both the end surfaces 40a of the light screen member 40 opposed to each other in the cutting direction of the light screen member side cut-out part 41 are arranged more inside than both the end faces 11b of the circuit board 11 opposed to each other in the cutting direction of the circuit board side cut-out part 14. Accordingly, when the circuit board 11 is arranged in the attaching position in the light transmitting housing 20, the light screen member 40 is arranged in the attaching position in the light transmitting housing 20. Therefore, an attaching operation can be made to be easy.

Further, in the LED lighting unit 1 according to the embodiment of the present invention, when the end parts 11 a of the circuit board 11 are respectively guided by the one pair of guide groove parts 21 to insert the circuit board 11 into the light transmitting housing 20, the light screen member 40 is allowed to abut on the abutting parts 22. Thus, the circuit board 11 is arranged in the attaching position in the light transmitting housing 20. Accordingly, the circuit board 11 can be easily attached to the attaching position in the light transmitting housing 20.

Further, in the LED lighting unit 1 according to the present invention, when the light screen member side engaging part 42 is engaged with the circuit board side engaging part 15, the light screen member 40 is engaged with the circuit board 11. Thus, the light screen member 40 can be assuredly fixed to the circuit board 11.

### FIRST MODIFIED EXAMPLE

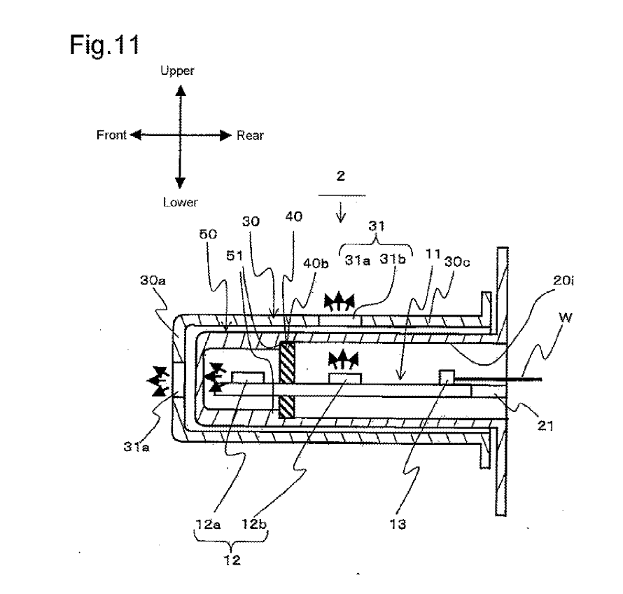

Now, by referring to FIG. 11, a first modified example of the LED lighting unit 1 of the embodiment of the present invention will be described below by referring to FIG. 11. FIG. 11 is a sectional view of main parts of an LED lighting unit 2 of a first modified example of the embodiment of the present invention.

The LED lighting unit 2 of the first modified example is different from the LED lighting unit 1 of the embodiment in view of a point that a light transmitting housing 50 has abutting parts 51 in place of the abutting parts 22.

Other structures are the same as those of the embodiment, and the same components as those of the embodiment are designated by the same reference numerals and signs.

The abutting parts 51 are stepped parts formed by changing the thickness of a wall of the light transmitting housing 50 to be large and surfaces orthogonal to an inserting direction of a circuit board 11 abut on a light screen member 40.

In the LED lighting unit 2 of the first modified example, the light screen member 40 is allowed to abut on the abutting parts 51, so that the circuit board 11 is positioned and arranged in an attaching position in the light transmitting housing 50. Accordingly, an attaching operation can be made to be easy like the LED lighting unit 1 of the embodiment.

### SECOND MODIFIED EXAMPLE

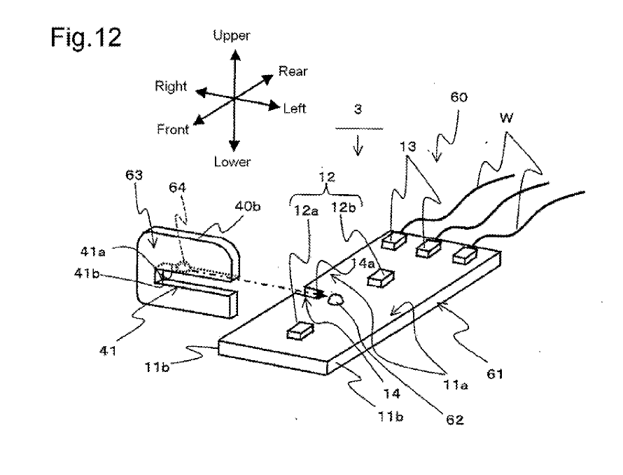

Now, a second modified example of the LED lighting unit 1 of the embodiment of the present invention will be described below by referring to FIG. 12. FIG. 12 is a perspective view of an LED unit part 60 and a light screen member 63 of an LED lighting unit 3 of the second modified example of the embodiment of the present invention.

In FIG. 12, since other structures than the LED unit part 60 and the light screen member 63 are the same as those of the LED lighting unit 1 of the embodiment, an illustration is omitted.

The LED lighting unit 3 of the second modified example is different from the LED lighting unit 1 of the embodiment in view of points that a circuit board 61 of the LED unit part 60 has a circuit board side engaging part 62 in place of the circuit board side engaging part 15 and the light screen member 63 has a light screen member side engaging part 64 in place of the light screen member side engaging part 42.

Other structures are the same as those of the embodiment, and the same components as those of the embodiment are designated by the same reference numerals and signs.

The circuit board side engaging part 62 is a protrusion arranged on an extending line of a cutting direction of a circuit board side cut-out part 14 and protruding from an upper surface of the circuit board 61.

The light screen member side engaging part 64 is a recessed part formed on an upper edge surface 41a of a pair of edge surfaces 41a opposed to each other in a direction orthogonal to a cutting direction of a light screen member cut-out part 41.

When the above-described circuit board side engaging part 62 is engaged with the light screen member side engaging part 64, the light screen member 63 is engaged with the circuit board 61.

In the LED lighting unit 3 of the second modified example, the circuit board side engaging part 62 is engaged with the light screen member side engaging part 64, so that the light screen member 63 is engaged with the circuit board 61. Accordingly, the light screen member 63 can be assuredly fixed to the circuit board 61 like the LED lighting unit 1 of the embodiment.

### THIRD MODIFIED EXAMPLE

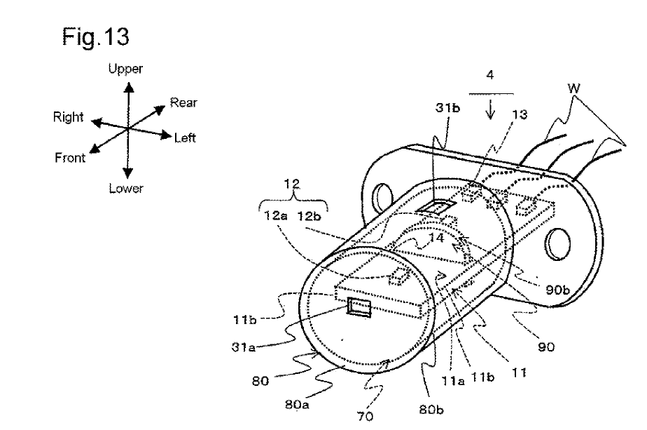

Now, a third modified example of the LED lighting unit 1 of the embodiment of the present invention will be described below by referring to FIG. 13. FIG. 13 is a perspective view showing an LED lighting unit 4 of the third modified example of the embodiment of the present invention.

The LED lighting unit 4 of the third modified example is different from the LED lighting unit 1 of the embodiment in view of points that a light transmitting housing 70 is provided in place of the light transmitting housing 20, a light screen cover 80 is provided in place of the light screen cover 30 and a light screen member 90 is provided in place of the light screen member 40.

Other structures are the same as those of the embodiment, and the same components as those of the embodiment are designated by the same reference numerals and signs.

The light transmitting housing 70 is made of a light transmitting synthetic resin material and has a bottomed cylindrical form. The light screen cover 80 is made of a synthetic resin having a light screen property, has a bottomed cylindrical form and is formed so as to cover an outer surface of the light transmitting housing 70.

The light screen member 90 is a plate shaped member formed so as to be accommodated in the light transmitting housing with an outer peripheral edge surface 90b allowed to come into sliding contact with an inner surface of the light transmitting housing 70.

In the LED lighting unit 4 of the third modified example, when edge surfaces 14a and 41b of a circuit board side cut-out part 14 and a light screen member side cut-out part 41 which are respectively orthogonal to cutting directions are allowed to abut on each other so as to attach the light screen member 90 to a circuit board 11, the light screen member 90 is attached to the circuit board 11 so that both end surfaces 40a of the light screen member 90 opposed to each other in the cutting direction of the light screen member side cut-out part 41 are arranged more inside than both end faces 11b of the circuit board 11 opposed to each other in the cutting direction of the circuit board side cut-out part 14. Thus, when the circuit board 11 is attached in the light transmitting housing 70, end parts 11a of the circuit board 11 are respectively guided by guide groove parts 21, the circuit board 11 is inserted into the light transmitting housing 70 and the light screen member 90 is allowed to abut on abutting parts 22, so that the circuit board 11 is positioned and arranged in an attaching position in the transmitting housing 70. Accordingly, an attaching operation can be made to be easy like the LED lighting unit 1 of the embodiment.

The LED lighting units 1, 2 and 3 according to the embodiment of the present invention are exemplified in which the light screen member side engaging part 42 is engaged with the circuit board side engaging part 15 so that the light screen member 40 is engaged with the circuit board 11. However, the present invention is not limited thereto. Namely, when the edge surfaces 14a and 41b respectively orthogonal to the cutting directions of the circuit board side cut-out part 14 and the light screen member side cut-out part 41 are allowed to abut on each other to attach the light screen member 40 to the circuit board 11 so that the light screen member 40 is held and fixed to the circuit board 11, the light screen member side engaging part 42 and the circuit board side engaging part 15 do not need to be provided.

Further, the LED lighting units 1, 2 and 3 according to the embodiment of the present invention are exemplified which respectively include the front side LED elements 12a and the rear side LED elements 12b, and the front side LED elements 12a emit the orange lights and the rear side LED elements 12b emit the white lights. However, the present invention is not limited thereto. Namely, the LED lighting unit that has a plurality of LED elements respectively emitting the while lights or colored lights, may emit other colors.

Further, the LED lighting units 1, 2 and 3 according to the embodiment of the present invention are exemplified which respectively include the two LED elements 12 of the front side LED element 12a and the rear side LED element 12b. However, the present invention is not limited thereto. Namely, the LED lighting unit may have a plurality LED elements.

Further, the LED lighting units 1, 2 and 3 according to the embodiment of the present invention are exemplified in which the light transmitting housings 20, 50 and 70 respectively include one pairs of guide groove parts 21. However, the present invention is not limited thereto. Namely, when the edges 11a of the circuit boards 11 and 61 are respectively guided so that the circuit boards 11 and 61 are arranged in attaching positions in the light transmitting housings 20, 50 and 70, other structures may be used. For instance, linear protruding parts which protrude linearly along inserting directions of the circuit boards 11 and 61 on inner walls of the light transmitting housings 20, 50 and 70 may be allowed to function as guide parts.

The invention devised by the inventor is specifically described above in accordance with the above-described embodiment of the present invention. However, the present invention is not limited to the above-described embodiment and may be variously changed within a range which does not depart from the gist thereof.

According to the present invention, when the edge surfaces of the circuit board side cut-out part and the light screen member side cut-out part which are respectively orthogonal to the cutting directions are allowed to abut on each other so as to attach the light screen member to the circuit board, the light screen member is attached to the circuit board so that both the end surfaces of the light screen member opposed to each other in the cutting direction of the light screen member side cut-out part are arranged more inside than both the end faces of the circuit board opposed to each other in the cutting direction of the circuit board side cut-out part. Accordingly, when the circuit board is arranged in the attaching position in the light transmitting housing, the light screen member is arranged in the attaching position in the light transmitting housing. Therefore, an attaching operation can be made to be easy.

Further, when the end parts of the circuit board are respectively guided by the one pair of guide groove parts to insert the circuit board into the light transmitting housing, the light screen member is allowed to abut on the abutting parts. Thus, the circuit board is arranged in the attaching position in the light transmitting housing. Accordingly, the circuit board can be easily attached to the attaching position in the light transmitting housing.

Further, when the light screen member side engaging part is engaged with the circuit board side engaging part, the light screen member is engaged with the circuit board. Thus, the light screen member can be assuredly fixed to the circuit board.

What is claimed is:

1. An LED lighting unit having a circuit board on which a plurality of LED elements are mounted and a light transmitting housing in which the circuit board is accommodated, the LED lighting unit including:
a light screen cover formed so as to cover an outer surface of the light transmitting housing and having light output opening parts formed on walls respectively opposed to the plurality of LED elements; and
a light screen member formed in a shape of a plate so as to be accommodated in the light transmitting housing with an outer peripheral edge surface allowed to come into sliding contact with an inner surface of the light transmitting housing and having a light screen member side cut-out part as a rectangular cut-out part which is cut from the outer peripheral edge surface to an inner part and has a width orthogonal to a cutting direction formed to be substantially equal to the thickness of the circuit board;
wherein the circuit board has a circuit board side cut-out part as a rectangular cut-out part which is cut from one end face of a pair of end faces opposed to each other in a direction orthogonal to an inserting direction to the light transmitting housing to an inner part of the circuit board, has a width orthogonal to a cutting direction formed to be substantially equal to the thickness of the light screen member and is arranged between the plurality of LED elements respectively, and when edge surfaces of the light screen member side cut-out part and the circuit board side cut-out part respectively orthogonal to the cutting directions are allowed to abut on each other to attach the light screen member to the circuit board, both end surfaces of the light screen member opposed to each other in the cutting direction of the light screen member side cut-out part are arranged more inside than both the end faces of the circuit board opposed to each other in the cutting direction of the circuit board side cut-out part.

2. The LED lighting unit according to claim 1, wherein the light transmitting housing has a pair of guide groove parts formed so as to guide respectively both end parts of the circuit board opposed to each other in the direction orthogonal to the inserting direction of the circuit board to the light transmitting housing and abutting parts which abut on the light screen member inserted into the light transmitting housing, and when the end parts of the circuit board are respectively guided by the pair of guide groove parts to insert the circuit board into the light transmitting housing, the light screen member is allowed to abut on the abutting parts, so that the circuit board is arranged in an attaching position in the light transmitting housing.

3. The LED lighting unit according to claim 1, wherein the light screen member has a light screen member side engaging part provided on at least one edge surface of a pair of edge surfaces opposed to each other in a direction orthogonal to the cutting direction of the light screen member side cut-out part and the circuit board has a circuit board side engaging part which is arranged on an extending line of the cutting direction of the circuit board side cut-out part and is engaged with the light screen member side engaging part.
